(19) United States
(12) Patent Application Publication
(10) Pub. No.: US 2026/0158432 A1
(43) Pub. Date: Jun. 11, 2026

(54) METHODS FOR HYDROGEN SULFIDE SCAVENGING

(71) Applicant: Hexion Inc.

(72) Inventors: Michael Lefenfeld, Columbus, OH (US); Jeffrey Lindeman, Columbus, OH (US); Cyrille Kamoun, Stafford, TX (US)

(73) Assignee: Hexion Inc., Columbus, OH (US)

(21) Appl. No.: 19/320,563

(22) Filed: Sep. 5, 2025

Related U.S. Application Data
(60) Provisional application No. 63/730,367, filed on Dec. 10, 2024.

(51) Int. Cl. B01D 53/14; B01D 53/52; B01D 53/78

(52) U.S. Cl. CPC B01D 53/1468; B01D 53/1493; B01D 53/52; B01D 53/78; B01D 2252/2021; B01D 2252/504; B01D 2252/606; B01D 2252/608; B01D 2257/304

(57) ABSTRACT

Disclosed is a process for scavenging H₂S from a process stream by contacting an H₂S-containing process stream with a scavenging composition containing 35 to 70 wt. % formaldehyde, 10 to 55 wt. % methanol, 5 to 20 wt. % water, and up to 10 wt. % additives, selected from a defoamer, a corrosion inhibitor, a scale inhibitor, a pH adjuster, or mixtures thereof. Scavenging compositions with such a formulation are also described.

### RELATED APPLICATION

This application claims priority to and any benefit of U.S. provisional patent application No. 63/730,367, filed Dec. 10, 2024, the content of which is incorporated herein by reference in its entirety.

### BACKGROUND

H₂S is often encountered in gaseous process streams present in the oil and gas, pharmaceutical, metals, paper and pulp, chemical processing, and hydrocarbon processing industries. H₂S is also present in underground water removed with crude oil, in crude oil itself, and in gases associated with such water and oil. For instance, H₂S is emitted as a gas which is associated with water and hydrocarbon vapors. Natural gases also contain H₂S. Not only are there many health hazards associated with H₂S, H₂S has detrimental effects on production equipment as it is highly corrosive and degrades process and storage infrastructure, leading to costly repairs. Accordingly, it is important to effectively control or scavenge H₂S.

Monoethanolamine (MEA)-triazine compositions are commonly used for scavenging H₂S from gaseous process streams. While MEA-triazine compositions scavenge H₂S adequately, such compositions have high moisture contents that significantly contribute to corrosion of downstream process equipment. Further, precipitate formed from the reaction of MEA-triazine and H₂S requires frequent downtime to remove the precipitate from equipment. Other H₂S scavengers include 3,3′-methylenebis(5-methyloxazolidine) (MBO). However, MBO's immiscibility with water, its cost, and its slow reaction kinetics with H₂S hinder its widespread use as a scavenger of H₂S.

Conventional MEA-triazine hydrogen sulfide scavengers have an ethanolamine to formaldehyde mole ratio of ≥1 (often 1.03). Although ethanolamine is relatively low in cost, MEA-triazine-based scavengers exhibit limitations in terms of cost-in-use, which is a critical parameter in the highly competitive hydrogen sulfide and sulfhydryl scavenger market. Given that MEA-triazine compositions are widely regarded as commodity products, cost-in-use has been a principal driver for commercial use of such scavengers. Other inconveniences include potential for over-reaction with hydrogen sulfide or other sulfhydryl compounds leading to precipitate formation requiring process shut down and clean out, high corrosivity (pH of 11.5-12), downstream corrosion and scaling issues (due to the high pH), high pour point/high freezing temperature not suitable with treatment in cold environment (to low flowability or even solidification). Solutions of MEA-triazine containing methanol are sometimes employed to mitigate precipitation issues and reduce pour point to acceptable levels; however, their effectiveness is limited, and the inclusion of methanol significantly lowers the flash point, increasing flammability.

There is a need for new processes for scavenging H₂S from H₂S-containing process streams, ones which eliminate the need for MEA.

### SUMMARY OF THE INVENTION

Aspects of the invention are directed to a method for scavenging H₂S from a process stream including the step of contacting an H₂S-containing process stream with a scavenger composition. A scavenger composition of the invention comprises, consisting essentially of, or consists of 35 to 70 wt. % formaldehyde, 15 to 55 wt. % methanol, 5 to 20 wt. % water, and 0 to 10 wt. % of a non-scavenging additive, selected from a defoamer, a corrosion inhibitor, a scale inhibitor, a pH adjuster, and mixtures thereof. In some aspects, the non-scavenging additive is present in the scavenger composition in an amount from 0.001 to 5 wt. %.

In an exemplary method of the invention, the process stream is a gaseous process stream and the contacting step includes passing the H₂S-containing process stream through the scavenger composition.

Other aspects of the invention are directed to a scavenger composition consisting essentially of or consisting of 35 to 70 wt. % formaldehyde, 10 to 55 wt. % methanol, 5 to 20 wt. % water, and from 0-10 wt. % of a non-scavenging additive selected from a defoamer, a corrosion inhibitor, a scale inhibitor, a pH adjuster, and mixtures thereof. In some aspects, the scavenger composition consists essentially of or consists of 40 to 65 wt. %, 45 to 60 wt. %, or 40 to 60 wt. % formaldehyde, 20 to 50 wt. %, 30 to 45 wt. %, or 35 to 50 wt. % methanol, 7 to 15 wt. %, 8 to 12 wt. %, or 8 to 10 wt. % water, and 0 to 10 wt. %, 0.001 to 8 wt. %, or 0.005 to 5 wt. % non-scavenging additive. In any aspect, the formaldehyde, methanol, water, and non-scavenging additive may be present in amounts that collectively add up to 100 wt. %.

Other aspects of the invention are directed to a scavenger composition comprising 35 to 70 wt. % formaldehyde; 10 to 55 wt. % methanol; and 5 to 20 wt. % water, wherein the scavenger composition is free of at least one of a triazine and an alkanolamine. In some aspects, the scavenger composition may be free of both a triazine and an alkanolamine.

### BRIEF DESCRIPTION OF THE DRAWINGS

The invention will be described in greater detail with reference to the drawings in which:

FIG. 1 illustrates the experimental apparatus used in Example 1.

FIG. 2 graphically illustrates the results of the hydrogen sulfide breakthrough test of Example 1.

FIG. 3 graphically illustrates the results of the hydrogen sulfide breakthrough test of Example 2.

FIG. 4 graphically illustrates the results of the hydrogen sulfide breakthrough test of Scavenger A in Example 4.

FIG. 5 graphically illustrates the results of the hydrogen sulfide breakthrough test of Scevenger B in Example 4.

### DESCRIPTION OF THE INVENTION

The invention relates to a method of scavenging H₂S and/or other sulfhydryl compounds from a process stream. Process streams that can be treated, denominated here as “H₂S-containing process streams” include, but are not limited to, gaseous process streams, crude oil, finished fuels, multiphase streams, natural gas, sour water and the like. A method of the invention contacts a process stream with a scavenger composition under conditions sufficient to remove substantially all H₂S and/or other sulfhydryl compounds from the process stream. The step of contacting may be accomplished by means known in the art such as but not limited to, injection of the scavenger composition into the process stream or passing the process stream through the scavenger composition. For liquid hydrocarbon process streams, as known in the art, a quaternary amine may be used to facilitate dispersion of the scavenger in the liquid hydrocarbon. In one embodiment of the invention, the method includes passing an H₂S-containing gaseous process stream through a scavenger composition. This may be accomplished using direct injection or a bubble tower.

A scavenger composition used in a method of the invention is a mixture of formaldehyde, methanol, and water, for example a mixture consisting essentially of or consisting of 35 to 70 wt. % formaldehyde, 15 to 55 wt. % methanol, and 5 to 20 wt. % water. By “consisting essentially of” these components, a scavenger composition does not contain other active scavenging species, such as a triazine, or scavenger precursors, such as an alkanolamine, e.g., monoethanolamine (MEA), but may contain other components, such as additives, to impart non-scavenging properties to the composition, such as pH, stability, defoaming, and the like. Such additives may be referred to herein as non-scavenging additives.

Although the invention is described herein as including methanol, it should be appreciated that other water soluble monoalcohols may be used in the alternative or in addition to methanol, including, for example, ethanol, propanol, isopropanol, butanol, isobutanol, and mixtures thereof, providing that such monoalcohols are not aminoalcohols.

A scavenger composition of the invention may be a mixture of 40 to 65 wt. % formaldehyde, 20 to 50 wt. % methanol, and 7 to 15 wt. % water, adding up to 100 wt. %; or a mixture of 45 to 60 wt. % formaldehyde, 30 to 40 wt. % methanol, and 8 to 12 wt. % water, adding up to 100 wt. %; or a mixture of 40 to 60 wt. % formaldehyde, 30 to 50 wt. % methanol, and 8 to 10 wt. % water, adding up to 100 wt. %. One such mixture is Methaform 55A, a product of Hexion, Inc., Columbus, OH, which contains 55+/−0.5 wt. % formaldehyde, 35+/−0.5 wt. % methanol, and 10+/−0.5 wt. % water. A scavenger composition used in the invention may be prepared by adding methanol, formaldehyde, and/or water to a composition such as Methaform 55 A. Any of the above scavenger compositions may further include from 0.1-10 wt. % of a non-scavenging additive, such that the mixture of formaldehyde, methanol, water, and any additives add up to 100 wt. %.

The molar ratio of total methanol to total formaldehyde in such a mixture used as a scavenger composition may range from 1:2 to 2:1 or 1:1.8 to 1.5:1 or 1:1.6 to 1.3:1 and may be 1:1.5, 1:1.60, 1:1.65, 1:1.70, 1:1.75, 1:1.80, 1:1.85, 1:1.90, 1:1, 1.02:1, 1.05:1, 1.08:1, 1.1:1, 1.15:1, 1.16:1, etc. The molar ratio of methanol to water may range from 1:0.6 to 4:1 or 1:0.5 to 3.5:1 or 1:0.4 to 3:1 and may be 1:0.25, 1:0.3, 1:0.35, 1:0.40, 1:0.45, 1:0.50, 1:0.55, or 1:0.6. In a mixture of formaldehyde, methanol, and water, much of the formaldehyde and/or methanol is not necessarily free but reacted with the methanol and exists as equilibrium products, such as methoxymethanol and/or methanediol (also known as formaldehyde hydrate). One of ordinary skill will understand that a scavenger composition used in the invention will have the equilibrium reaction product of methanol and formaldehyde, that is methoxymethanol, as shown in reaction (1). This equilibrium favors the formation of methoxymethanol. A scavenger composition used in the invention will also have the equilibrium product of water and formaldehyde, that is methanediol, as shown in reaction (2). This equilibrium favors the formation of methanediol.

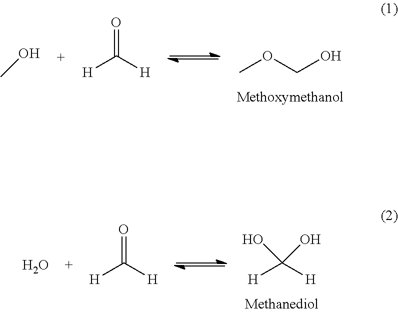

Such a mixture may then contain at least an equilibrium mixture of the methanol, formaldehyde, water and the equilibrium reaction products. Other equilibrium reactions and equilibrium products (e.g. poly(oxymethylene) glycols and poly(oxymethylene) hemiformals) may also be present. See, e.g., Albert et al., Vapor-Liquid Equilibrium of Aqueous Solutions of Formaldehyde and Methanol, AIChE Journal, 2000, vol. 46, no. 8, p. 1676; and Hahnenstein et. al., NMR Spectroscopic and Densimetric Study of Reaction Kinetics of Formaldehyde Polymer Formation in Water, Deuterium Oxide, and Methanol, Ind. Eng. Chem. Res., 1995, 34, 440; both of which are incorporated here by reference.

Methoxymethanol solutions exhibit superior stability at ambient and low temperatures, unlike conventional aqueous formaldehyde solutions, which tend to form insoluble paraformaldehyde via polymerization. Methoxymethanol possesses significantly lower volatility than methanol, with a lower vapor pressure, a higher boiling point (82.5° C. vs. 64.7° C.), and a higher flash point (39.9° C. vs. 12° C.), rendering it less flammable and safer to handle. In scavenger formulations, methoxymethanol effectively inhibits formaldehyde polymerization and prevents paraformaldehyde precipitation, even at concentrations equivalent to 50-52 wt. % formaldehyde solutions. Additionally, methoxymethanol contributes to low viscosity, extended shelf life, and improved low-temperature performance, including a reduced pour point and freezing temperature of the composition.

A mixture of formaldehyde, methanol, and water, useful as a scavenger composition in a process of the invention, remains stable and liquid even at very low temperatures (e.g., −40° C.). A method of the invention yields a spent scavenger having a high stability, with absence of precipitate fouling in overspent scavenger (well beyond breakthrough values). Although highly concentrated in sulfur, the spent scavenger composition is entirely liquid even at low temperatures (e.g., −40° C.) and is stable over time. The spent scavenger does not separate into two liquid phases. It remains as a single liquid phase. Methods of the invention may therefore advantageously be used in very cold weather conditions.

Foam may build up when performing the process for scavenging H₂S from a gaseous process stream. Accordingly, a scavenger composition of the invention may further include a suitable defoamer. The defoamer prevents or destroys foam bubbles during H₂S scavenging processes and may improve the H₂S scavenging processes. Any defoamer used in the art may be used. Exemplary defoamers include alcohols, fatty acids, fatty acid esters, silicone glycols, alkyl polyacrylates and the like. A scavenger composition of the invention may further include a scale inhibitor to prevent the formation of mineral scales. Any scale inhibitor in the art may be used. Exemplary scale inhibitors include phosphonates and derivatives thereof. A scavenger composition of the invention may further include a corrosion inhibitor. Any corrosion inhibitor in the art may be used. Exemplary corrosion inhibitors include imidazolines, including quaternized imidazolines, phosphate esters, and the like. A scavenger composition of the invention may further include a pH adjuster. Any pH adjuster in the art may be used. Exemplary pH adjusters include sodium hydroxide (NaOH) and formic acid (HCO₂H). Such additives (defoamer, corrosion inhibitor, scale inhibitor, and/or pH adjuster) may be present in up 10 wt. % (i.e., 0 to 10 wt. %) of the scavenger composition and may be present, for example, in 0.001-10 wt. %, including for example, 0.005-8 wt. %, 0.01-8 wt. %, 0.05-8 wt. %, 0.1-6.5 wt. %, 0.5-5 wt. %, or 1-7 wt. %. The invention also relates to a scavenger composition containing 35 to 70 wt. % formaldehyde, 10 to 55 wt. % methanol, 5 to 20 wt. % water, and from 0.1-10 wt. % of an additive selected from a defoamer, a corrosion inhibitor, a pH adjuster, and mixtures thereof, adding up to 100 wt. %. A scavenger composition of the invention may contain each of these components in the various amounts discussed above.

In one embodiment a method of the invention may be used to scavenge H₂S from any suitable H₂S-containing gaseous process stream. For example, the scavenger composition may be used to remove H₂S present in natural gas, such as those produced from natural gas wells, including where the media is a gas phase. The scavenging process may be achieved using suitable equipment and suitable scavenging conditions. The scavenging process may be practiced by passing an H₂S-containing gaseous process stream through the scavenger composition. For example, the scavenging process may be practiced by contacting the H₂S-containing gaseous process stream with droplets of a scavenger composition.

Removal of H₂S from a H₂S-containing gaseous process stream by scavenger compositions described herein may be performed by direct addition of the scavenger compositions to a flowing H₂S-containing gaseous process stream or in a gas-liquid contactor or scrubber, such as a bubble column, packed column, or tray column; or by other suitable means to increase gas/liquid contact time and/or surface area. H₂S in sour liquid streams may be sparged or stripped into a gas phase, and that gas phase sent to a gas-liquid contactor, or direct liquid-liquid contact may be used. The spent reaction liquid, comprising reacted scavenger composition, may be removed and, optionally, replaced with fresh scavenger composition all at once batchwise, or the spent reaction liquid may be continuously transferred to a wastewater treatment facility or otherwise discarded and replenished with fresh scavenger composition at a controlled rate.

### EXAMPLES

Methaform 55A, a product of Hexion, Inc., Columbus, Ohio, was used in the following examples. Methaform 55A is an aqueous solution containing mainly methoxymethanol, some formaldehyde hydrate, some methanol and a small amount of water from a mixture of 55 wt. % formaldehyde, 35 wt. % methanol and 10 wt. % water. The molar ratio of methanol to formaldehyde is 0.60:1. The molar ratio of water to formaldehyde is 0.30:1.

### Example 1: H₂S Breakthrough Testing

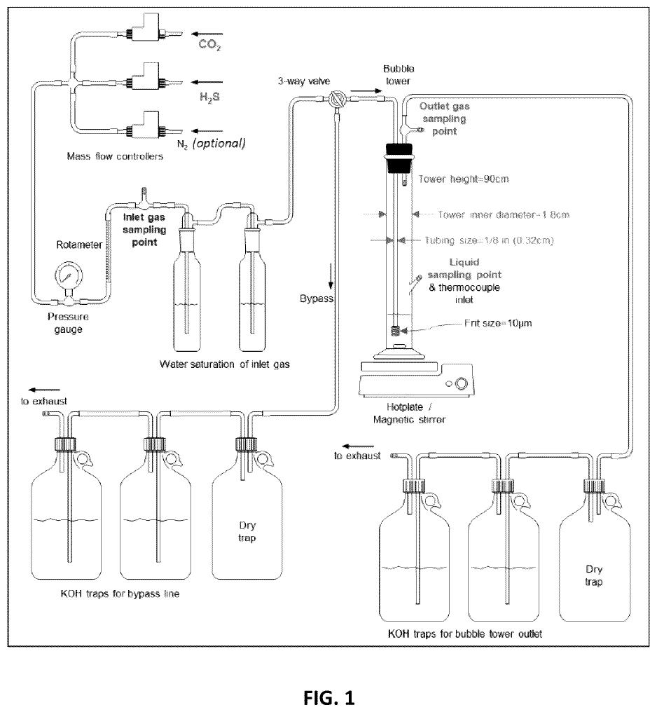

An H₂S breakthrough test was conducted with Methaform 55A. The breakthrough test was a stressed performance evaluation test measuring H₂S uptake. Using the experimental apparatus shown in FIG. 1, the test to measure H₂S uptake involved flowing (bubbling) the feed gas at a constant flow rate through 50 mL of the scavenger formulation at room temperature (approx. 20° C.). The composition of the feed gas consisted of ˜18% H₂S balanced with CO₂ at a total flow rate of 200 mL/min. The outlet and inlet gases were sampled at regular time intervals (7 to 10 minutes) and analyzed using a calibrated gas chromatograph coupled with a thermal conductivity detector (GC-TCD). The experiment continued until the outlet H₂S levels reached >3 mol % (i.e., the scavenger is only scavenging 83% of the inlet H₂S). Equivalent H₂S content in the liquid was calculated at breakthrough, from the GC data for the outlet gas. These data allowed for the comparative efficiency and overall capacity of each test solution to be calculated. For the experimental method and apparatus, see, Optimising Scavenger Testing Protocol at ASRL, M. Madekufamba, D. Mercer, H. H. Wan., F. Bernard and R. A. Marriott, pp. 3-18, ASRL QB Vol. LV, No. 3, October-December 2018.

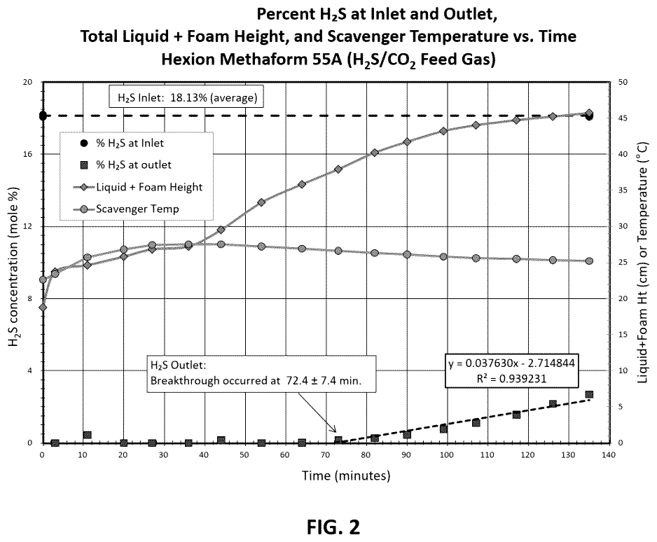

The hydrogen sulfide used in the breakthrough test was a mixture of 18% mol H₂S and 82% mol CO₂ to prove the specificity of these scavengers to hydrogen sulfide (and the absence of reaction with carbonic gas). The test was not stopped immediately after the breakthrough; the scavenger was exposed to an excess of H₂S on purpose to simulate an overspending situation sometimes encountered in the field with contact/bubble towers. The test was completed when the outlet gas contained 3% mol H₂S. The results are shown in Table 1 and in FIG. 2. At the completion of the test, the spent scavenger was a single-phase solution, clear and colorless. It remained so overnight and for one week after the test.

TABLE 1

| | | | | Initial | Foam + Liquid | Final | Foam |
|---|---|---|---|---|---|---|---|
| | H₂S | | Total H₂S Content | Liquid | Height at End | Liquid | break |
| | Delivery | Breakthrough | at Breakthrough | height | of Flow^{††} | height | time |
| Sample | (mL/min) | Point (min) | (mg H₂S/50 mL)^{†} | (cm) | (cm @ min) | (cm) | (s) |
| Methaform | 36.8 ± 0.8 | 72.4 ± 7.4 | 3325 ± 332 | 18.7 | 45.7 cm @ | 20.6 | 19 |
| 55A | | | | | 135 min | | |

^{†}Calculated H₂S content in liquid at the breakthrough point based on time integration of H₂S inlet less outlet.
^{††}Liquid + Foam Height refers to the height of the column of liquid scavenger and foam that is formed on top. The initial liquid height is 18.7 cm.

### Example 2: Comparison H₂S Breakthrough Testing

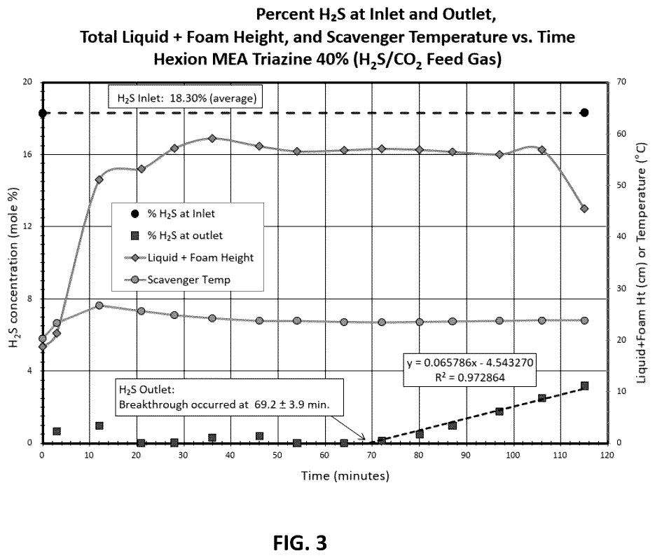

A 40 wt. % MEA Triazine scavenger, available from Hexion, Inc., Columbus, OH, was used as a comparison for H₂S breakthrough testing using the same procedure as described in Example 1. The results of the breakthrough test with this control are shown in FIG. 3. The spent scavenger of the standard 40 wt. % MEA triazine came out as 3 phases overnight: 2 liquid phases and a precipitate of dithiazine polymer, which reproduced the accidental undesired fouling sometimes observed in the field in contact/bubbles towers. Table 2 compares the properties of Methaform 55A, used in Example 1, and a 40 wt. % MEA Triazine composition.

TABLE 2

| | | 40 wt. % MEA |
|---|---|---|
| Property | Methaform 55A | Triazine |
| Free Methanolamine (wt. %) | 0 | 0.8-1.4 |
| MEA-Triazine Content (wt. %) | 0 | 39-41 |
| Methanol (wt. %) | 34.5-35.5 | <1 |
| Total Vapor Pressure (mm Hg) at | 23.39 | |
| 25° C. | | |
| Boiling Point (° C.) | 97 | 100 |
| Flash Point (° C.) (Pensky- | 43 | >93 |
| Martens, Closed Cup) | | |
| pH | 5-6 | 10-12 |
| Appearance at 25° C. | Clear colorless | Clear to light |
| | liquid | yellow liquid |
| Color (min.-max.) Garner APHA, | 0-10 | 0-60 |
| Nessler | | |
| Refractive Index at 25° C. | 1.3857-1.3957 | 1.4010-1.4110 |
| Viscosity at 25° C. (cP) | 2-4 | 5-8 |
| Specific Gravity at 25° C. | 1.078-1.088 | 1.061-1.071 |
| Density (lb/Gal) at 20° C. | 8.86-8.94 | 8.99-9.07 |
| Pour point (° C.) | <−45 | −13 |
| Surface tension at 25° C. (mN/m) | 32-35 | 56-59 |

### Example 3: Preparation of Scavenger Compositions A-B

Scavenger compositions A and B were prepared by adding methanol to Methaform 55A at room temperature. Scavenger compositions useful in the invention may also be prepared by combining the components in one or more steps. Table 3 shows the amounts of Methaform 55A and methanol combined and the amounts of formaldehyde, methanol, and water in the scavenger composition. Table 4 lists the properties of scavenger compositions A and B

TABLE 3

| Scav- | | | | | | |
|---|---|---|---|---|---|---|
| enger | Materials | Amount | | Composition | Amount | |
| A | Methaform 55A | 93.1 | wt. % | Formaldehyde | 51.5 | wt. % |
| | Methanol | 6.9 | wt. % | Methanol | 38.9 | wt. % |
| | | | | Water | 9.6 | wt. % |
| B | Methaform 55A | 80.0 | wt. % | Formaldehyde | 44.3 | wt. % |
| | Methanol | 20.0 | wt. % | Methanol | 47.5 | wt. % |
| | | | | Water | 8.2 | wt. % |

TABLE 4

| Property | Scavenger A | Scavenger B |
|---|---|---|
| Flash Point (° C.) | 38 | 35 |
| (Pensky-Martens, Closed Cup) | | |
| pH | 5.52 | 5.50 |
| Appearance at 25° C. | Clear colorless | Clear colorless |
| | liquid | liquid |
| Color (min.-max.) | 0-10 | 0-10 |
| Garner APHA, Nessler | | |
| Refractive Index at 25° C. | 1.3876 | 1.3770 |
| Viscosity at 25° C. (cP) | 2.4 | 1.8 |
| Specific Gravity at 25° C. | 1.0523 | 1.0013 |
| Density (lbs/Gal) at 20° C. | 8.76 | 8.37 |
| Pour point (° C.) | −30 | <−45 |

### Example 4: Breakthrough Testing

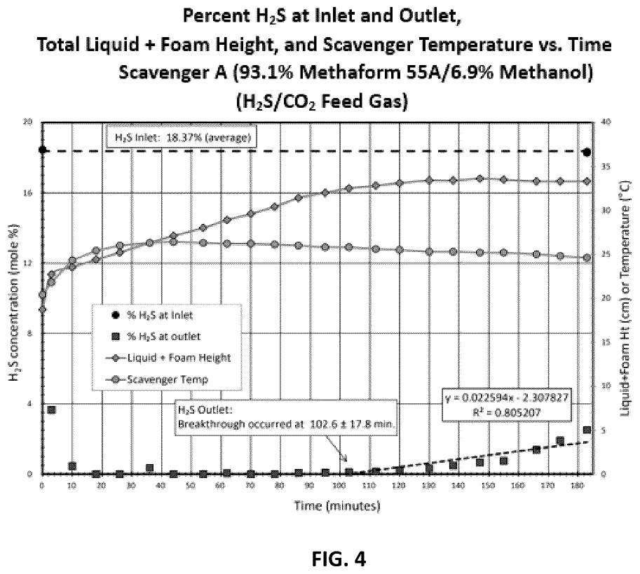

Breakthrough testing for Scavenger A was performed using the same procedure as described in Example 1. Scavenger A was single-phase, clear and colorless prior to gas flow. The foam was at moderate levels and increased steadily toward the breakthrough point and remained at a steady level thereafter (ca. 33 cm in a 90 cm-tall test tower). Breakthrough time was 102.6±17.8 min H₂S slip was observed in the first two sample points. The sample retained the same appearance over the course of the test as well as after standing overnight at room temperature, which indicates that Scavenger A is non-fouling. This is particularly apparent when compared to 40% MEA-triazine as described in Example 2. The results of the breakthrough test are shown in Table 5 and in FIG. 4.

Breakthrough testing for Scavenger B was performed using the same procedure as described in Example 1. Scavenger B was single-phase, clear and colorless prior to gas flow. It developed a small amount of foam during the test. Its temperature was also relatively stable. Breakthrough was very gradual, with a very small amount of H₂S observed at the outlet from 60 min onward. Breakthrough time was 72.6±14.7 min, and the outlet H₂S content increased slowly thereafter. The test was concluded at 153 min. The sample remained single phase and clear at the end of the test with no precipitates and appeared to be the same after standing overnight, which indicates that Scavenger B is non-fouling. This is particularly apparent when compared to 40% MEA-triazine as described in Example 2.

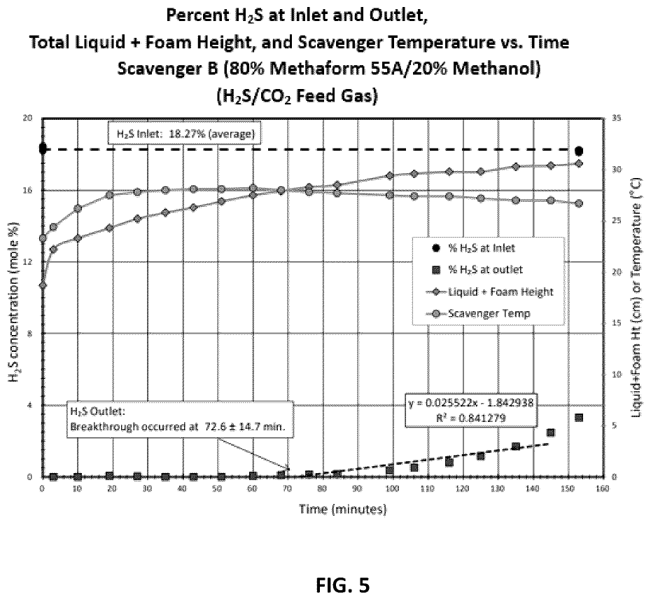

The results of the breakthrough test are shown in Table 5 and in FIG. 5.

TABLE 5

| | | | Total H₂S | | Foam + Liquid | Total flow | H₂S | | |
|---|---|---|---|---|---|---|---|---|---|
| | | | Content at | Initial | Height at | time/ | content at | Final | Foam |
| | H₂S | | Breakthrough | Liquid | End of | End of | end of | Liquid | break |
| | Delivery | Breakthrough | (mg H₂S/50 | height | Flow^{††} | experiment | experiment | height | time |
| Scavenger | (mL/min) | Point (min) | mL) ^{†} | (cm) | (cm @ min) | (minutes) | (mg H₂S) | (cm) | (s) |
| A | 37.4 ± 0.8 | 102.6 ± 17.8 | 4681 ± 804 | 18.7 | 33.3 cm @ | 183 ± 0.2 | 8312 ± 416 | 20.8 | 10 |
| | | | | | 183 min | | | | |
| B | 37.2 ± 0.8 | 72.6 ± 14.7 | 3343 ± 664 | 18.7 | 30.6 cm @ | 153 ± 0.2 | 6798 ± 340 | 20.1 | 8 |
| | | | | | 153 min | | | | |

^{†} Calculated H₂S content in liquid at the breakthrough point based on time integration of H₂S inlet less outlet.
^{††}Liquid + Foam Height refers to the height of the column of liquid scavenger and foam that is formed on top. The initial liquid height is 18.7 cm.

The terminology used here, and the above examples, serve to explain not to limit the disclosure. Unless a specific context demands otherwise, singular terms should be read to include their plural forms and vice versa, and the articles “a,” “an,” and “the” are interchangeable with “at least one.”

The verbs “include” and “including” are intended to be open-ended in the same way “comprise” and “comprising” are interpreted in patent claims. Likewise, the conjunction “or” should be understood as “A or B or both,” unless the text expressly says, “only A or B, but not both.”

Unless the context states otherwise, any set of process steps described here can be carried out in any order.

All numerical values—amounts, temperatures, pressures, and so on—are to be taken as “about” those numbers, interpreted in light of significant digits and ordinary rounding. A stated range such as “1 to 10” covers every sub-range and individual value between 1 and 10, for example 1 to 6.1 or 2.3 to 9.4, as well as each integer from 1 through 10.

Each expression of the invention described here (e.g., method, composition, apparatus) may comprise, consist essentially of, or consist of the elements set out in this disclosure together with any optional features useful in an invention or in any preferred or derived embodiment.

The claimed invention is:

1. A method for scavenging H₂S from a process stream comprising the step of:
contacting an H₂S-containing process stream with a scavenger composition consisting essentially of 35 to 70 wt. % formaldehyde, 15 to 55 wt. % methanol, 5 to 20 wt. % water, and 0 to 10 wt. % of a non-scavenging additive, selected from a defoamer, a corrosion inhibitor, a scale inhibitor, a pH adjuster, and mixtures thereof.

2. A method of claim 1, wherein the scavenger composition consists essentially of 40 to 65 wt. % formaldehyde, 20 to 50 wt. % methanol, 7 to 15 wt. % water, and 0 to 10 wt. % non-scavenging additive.

3. A method of claim 2, wherein the scavenger composition consists essentially of 45 to 60 wt. % formaldehyde, 30 to 40 wt. % methanol, 8 to 12 wt. % water, and 0 to 10 wt. % non-scavenging additive.

4. A method of claim 3, wherein the scavenger composition consists essentially of 40-60 wt. % formaldehyde, 30-50 wt. % methanol, 8-10 wt. % water, and 0 to 10 wt. % non-scavenging additive.

5. A method of claim 1, wherein the non-scavenging additive is present in the scavenger composition in an amount from 0.001 to 5 wt. %.

6. A method of claim 1, wherein the process stream is a gaseous process stream, and the contacting step passes the H₂S-containing process stream through the scavenger composition.

7. A method of claim 1, wherein the scavenger composition is non-fouling.

8. A scavenger composition consisting essentially of 35 to 70 wt. % formaldehyde, 10 to 55 wt. % methanol, 5 to 20 wt. % water, and from 0-10 wt. % of a non-scavenging additive selected from a defoamer, a corrosion inhibitor, a scale inhibitor, a pH adjuster, and mixtures thereof.

9. A scavenger composition of claim 8, consisting essentially of 40 to 65 wt. % formaldehyde, 20 to 50 wt. % methanol, 7 to 15 wt. % water, and 0 to 10 wt. % non-scavenging additive.

10. A scavenger composition of claim 8, consisting essentially of 45 to 60 wt. % formaldehyde, 30 to 40 wt. % methanol, 8 to 12 wt. % water, and 0 to 10 wt. % non-scavenging additive.

11. A scavenger composition of claim 8, consisting essentially of 40 to 60 wt. % formaldehyde, 30 to 50 wt. % methanol, and 8 to 10 wt. % water, and 0 to 10 wt. % non-scavenging additive.

12. A scavenger composition of claim 8, wherein the non-scavenging additive is present in the scavenger composition in an amount from 0.001 to 5 wt. %.

13. A scavenger composition of claim 8, wherein the formaldehyde, methanol, water, and non-scavenging additive are present in amounts that collectively add up to 100 wt. %.

14. A scavenger composition comprising:
35 to 70 wt. % formaldehyde;
10 to 55 wt. % methanol; and
5 to 20 wt. % water, wherein the scavenger composition is free of at least one of a triazine and an alkanolamine.

15. A scavenger composition of claim 14, wherein the scavenger composition is free of a triazine and an alkanolamine.

16. A scavenger composition of claim 14, wherein the composition further includes up to 10 wt. % of a non-scavenging additive selected from a defoamer, a scale inhibitor, a corrosion inhibitor, a pH adjuster, and mixtures thereof.

17. A scavenger composition of claim 16, wherein the defoamer is selected from the group consisting of an alcohol, fatty acid, fatty acid ester, silicone glycol, alkyl polyacrylate, and mixtures thereof.

18. A scavenger composition of claim 14, wherein the composition includes formaldehyde, methanol, water, and a non-scavenging additive in amounts that collectively add up to 100 wt. %.

19. A scavenger composition of claim 14, wherein the composition consists essentially of 40 to 65 wt. % formaldehyde, 20 to 50 wt. % methanol, 7 to 15 wt. % water, and 0.001 to 8 wt. % non-scavenging additive.

20. A scavenger composition of claim 14, wherein the composition consists essentially of 40-60 wt. % formaldehyde, 30-50 wt. % methanol, 8-10 wt. % water, and 0.005 to 5 wt. % non-scavenging additive.
